(19) United States
(12) Patent Application Publication
(10) Pub. No.: US 2004/0173779 A1
(43) Pub. Date: Sep. 9, 2004

(54) Biodegradable shaped article containing a corrosion inhibitor and inert filler particles

(76) Inventors: Mehmet A. Gencer, Brecksville, OH (US); Donald A. Kubik, Dickenson, ND (US); Ramani Narayan, Okemos, MI (US); Efim Ya Lyublinski, Solon, OH (US)

Correspondence Address: Alfred D. Lobo & Co., L.P.A., 933 The Leader Building, 526 Superior Avenue E, Cleveland, OH, 44114-1902, US

(21) Appl. No.: 10/805,137

(22) Filed: Mar. 20, 2004

Related U.S. Application Data
(63) Continuation-in-part of application No. 10/676,752, filed on Oct. 1, 2003.
Application No. 10/676,752 is a continuation-in-part of application No. 10/453,304, filed on Jun. 3, 2003.
Application No. 10/453,304 is a continuation-in-part of application No. 10/396,067, filed on Mar. 25, 2003.
Application No. 10/396,067 is a continuation-in-part of application No. 10/054,031, filed on Jan. 22, 2002, now abandoned.
Application No. 10/396,067 is a continuation-in-part of application No. 10/054,032, filed on Jan. 22, 2002, now abandoned.

(51) Int. Cl. C09K 3/00; C23F 11/00

(52) U.S. Cl. 252/387

(57) ABSTRACT

A biodegradable polymer (“biopolyrner) filled with more than 5 wt %, and up to about 35 wt % of an inert particulate filler so as to have a WVTR in the range from at least twice to about 50 times greater than that of low density PE having a melt flow index of 1 g/10 min, each of the same thickness, is more effective to protect metal parts against corrosion than “neat” or unfilled biopolymer. Moreover a cross-section of the filled biopolymer 0.025 mm thick, is substantially transparent if the neat biopolymer is transparent. The improvement in corrosion protection is obtained without decreasing the tensile strength of the film below a critical tensile strength of 2000 psi in either the machine or transverse direction, preferably in both directions, due to the uniformity of the dispersed particles in the filled biopolymer. Such uniformity is obtained because the ingredients in the biopolymer are essentially anhydrous.

### CROSS-REFERENCE TO RELATED APPLICATIONS

This application is a continuation-in-part application of Ser. No. 10/676,752 filed 1 Oct. 2003, which is a continuation-in-part application of Ser. No. 10/453,304 filed 3 Jun. 2003, which is a continuation-in-part application of Ser. No. 10/396,067 filed 25 Mar. 2003, which is a continuation-in-part application of Ser. Nos. 10/054,031 and 10/054,032, both filed on 22 Jan. 2002.

### FIELD OF THE INVENTION

The present invention relates to a thermoplastic biodegradable, preferably fully biodegradable polymer (“biopolymer”) having uniformly dispersed therein a mixture of an inert particulate filler and at least one particulate, vapor phase inhibiting (“VPI”) or volatile corrosion inhibiting (“VCI”) ingredient in a polymeric article of arbitrary shape and cross-section. By “fully biodegradable” is meant that the polymer meets ASTM and ISO standards of biodegradability and is essentially completely biodegraded or assimilated by microorganisms. Most preferred biopolymers are degraded in less than one year. By “inert” is meant that the filler particles are environmentally friendly and do not react chemically with either the polymer or any of the additives therein. It is essential that the VCI and filler are to be substantially uniformly dispersed within the mass of a thermoplastic biopolymer which is to be shaped so as to form a sealed enclosure for a corrosion-prone or tarnish-prone metal object. Though ingredients effective to convert the polymer into a VCI polymer are also inert relative to the polymer, and are technically also “filler” particles, the term “filler particles” as used herein refers specifically to particles other than those to which the corrosion or tarnish inhibition is attributable, such filler particles being talc, calcium carbonate, silica, and the like.

The shaped article is typically a synthetic resinous (hereafter also “plastic”) box-like container or film such as is used to protect metal objects packaged for storage and transportation. Typically, the shaped article is an extruded, blown or cast sheet of film which can be wrapped around the metal object and sealed; or, wrapped around a container in which the metal object is held, then sealed; or, the shaped article is a container, such as a box or gun case which is injection molded, blow molded, or otherwise thermoformed; or, a liner less than 0.25 mm thick, to be inserted in the box or gun case.

Metal objects, including ferrous ones, are commonly packaged in either a polyolefinic (“PO”) bag or flexible container of PO film,-typically-polyethylene (“PE”) or polypropylene (“PP); or, in a rigid cardboard or wood container which is lined with a relatively flexible film in which metal parts are sealed. Dispersed in conventional “VCI film”, as an integral part thereof, is a small amount of inert filler particles, typically silica, no more than 5 parts by weight of particles in 100 parts of thermoformed article (5 % by weight or 5 wt %) and an effective amount of VCI ingredient, more preferably a combination of VCIs providing protection for a year or more.

A VCI in a polymer functions as such because its effectiveness derives from diffusion of the compound, such as vapor of the compound diffusing through the polymer. In a combination of compounds, the effectiveness of protection accorded is necessarily attributed to the combined vapor pressure exerted by the VCIs which provide the corrosion protection without the VCI compounds themselves directly contacting the metal surfaces of an article being protected; the wall of the container, or the plastic wrap around the article, is generally spaced apart from the surface; vapor diffuses through the plastic in which the VCIs are dispersed and inhibits corrosion of metal held in the sealed space within the plastic.

The Problem

To provide a compostable “filled” VCI biopolymer which is more effective than known biodegradable VCI biopolymers; further, in the event that metal objects are to be viewable, though sealed in a compostable VCI biopolymer, “filled” biofilm 0.025 mm thick and containing more than 5 wt % of inert filler particles, is required to be substantially transparent.

### BACKGROUND OF THE INVENTION

As disclosed in U.S. Pat. No. 4,290,912 issued to Boerwinkle et al, about two decades ago, effective corrosion protection is provided by a thermoprocessable polymer containing a hindered phenol in combination with an alkali metal nitrite, and less than 1 wt % of silica. The PE or PE/polyester films specifically disclosed therein may contain additional additives such as are conventionally used to improve the processability and stability of the polymer, for example, antioxidants, processing aids, heat stabilizers, and the like.

Since, to be effective, vapor of a VCI in the polymer must escape the polymer, it is counterintuitive to impede-escape of the vapor by surrounding a small number of particles of the VCI with a several-fold larger amount of inert filler particles. Moreover, uniformly distributing the inert filler particles in a size range conducive to packing the particles around and with the VCI particles, assuming this could be done, would appear only further to hinder escape of the vapor. However, for reasons set forth herebelow, it has been found particularly desirable to infuse the biopolymer with a major amount, relative to all other additives in the polymer, by weight of an inert particulate, micron-sized (“micronized”) filler, and to do so (i) without decreasing the water vapor transmission rate (WVTR) of the “filled” biopolymer relative to that without any particles, that is, “unfilled” or “neat” biopolymer, and, (ii) yet maintaining the tensile strength of the filled polymer at 2000 psi or above, at ambient temperature (23° C.), measured in at least one direction, whether machine or cross, this being the acceptable critical limit of minimum tensile strength of PE film currently used. The WVTR is not to be confused with water permeation rate. “Micronized particles” refers to primary particles in the size range from about 1μm-45 μm. All references to “diameter” or “equivalent diameter” herein refers to the diameter of a particle as measured by a Microtrac-X 100 which measures sizes in the range from 0.04-704 μm of particles suspended in a liquid by laser light diffraction and dynamic light scattering. Tensile strength is measured according to ASTM 882-01 which is incorporated by reference thereto as if fully set forth herein. The conventional way to disperse a particulate ingredient, smaller than about 45 μm (micrometers) into any polymer, is by melt-processing a mixture of the ingredient and polymer, either in an extruder, or by plasticizing the polymer sufficiently so as to then be able to mix the ingredient into the plasticized mass. However, when as little as 3 wt % of sodium nitrite is incorporated in a thermoformable polymer, particles agglomerate, such agglomeration being particularly severe in any biopolymer. In the particular instance where the sodium nitrite is incorporated into the polymer as particles in the size range from about 1 μM to 45 μm, all of which pass through a 325 mesh screen or 45 μm (Standard Test Sieves), large agglomerates of small particles, each agglomerate greater than 50 μm, are formed. The formation of agglomerates does not allow the small particles to be uniformly distributed and packed around the VCI in the polymer when an article is molded, or a film is extruded, causing an expected decrease in tensile strength. Further, large agglomerates decrease the strength of film, get caught in screens inside an extruder (which screens are used to protect the die from damage by large particles), and cause the polymer's melt-processed surface to be noticeably rough to the touch, compared to a smooth surface of the same polymer without any particles.

The “uniformity” problem was discovered when an article molded from a substantially transparent, water-white biodegradable film (“biofilm”) molded with 3 wt % of the sodium nitrite particles at a temperature above about 190° C. (374° F.) but below which the biopolymer would be degraded, became noticeably weakened and opaque, that is, not substantially transparent. By “substantially transparent” is meant that a film 0.025 mm (1 mil) thick is sufficiently light-permeable so that 12-point (font) print on this page can be read through the film, irrespective of its color; films as thick as 0.125 mm (5 mils) may be substantially transparent. Surprisingly, despite high scattering of light from smaller particles, that is in a range from about 1-10 μm, with a high aspect ratio, 3 wt % particles are invisible when uniformly dispersed in blown or cast film which is substantially transparent, but such transparency is lost when the particles agglomerate.

It was therefore expected that when more than 5 wt % of any particles in the size range of about 1-45 μm, dispersed in a biopolymer having a cross-section of 25 μm (0.001″ or 0.025 mm), would not be substantially transparent.

It is evident that a much smaller concentration of particles than 5 wt % would be visible in the film if the particles were opaque. For example, as little as about 3 wt % of dark particles, such as of carbon black, is sufficient to opacify commercially available black PE film; because the film is opaque, whether the distribution of particles is uniform is immaterial.

Since substantially transparent film less than 0.125 mm (5 mils) thick, in which to store articles, is most preferred, unless the articles are meant to be deliberately hidden, it is counterintuitive to add more than 5 wt % of an inert filler to film if it is to be expected to remain substantially transparent. Moreover, it would be expected that addition of inert particles in the polymer, even if uniformly distributed, will greatly decrease its tensile strength at break, its elongation at break, its tensile modulus of elasticity, and its Elmendorf tear strength; the higher the concentration of inert particles in the film, the stiffer and weaker the film, and, both the stiffness and the rigidity are greatly increased by large agglomerates in the polymer;

It is well known, as stated in U.S. Pat. Nos. 6,028,160 and 6,156,929 to Chandler et al, that “commercially available biodegradable films have significantly higher breathability and moisture attraction and permeability. Because of these physical properties, biodegradable plastic films typically offer less protection to metallic articles than is available from the more traditional polyolefin films. However, this disadvantage may be overcome when the biodegradable plastic resin film is combined with a particulate vapor phase corrosion inhibitor dispersed within and through the film or coated on the surface of the film. The selected vapor phase corrosion inhibitors used in connection with the present invention are highly compatible with biodegradable resins and films, and offer significant protection to metallic articles within an enclosure.” (see '929, col 1, lines 49-62). As would be expected, though neither “neat” PE nor “neat” biofilm, each 0.025 mm thick, would be expected to provide much protection against corrosion, it will be evident from the data presented below, that the biofilm provides better, not worse, protection despite its much higher WVTR relative to PE. Further, though it is unclear what highly compatible refers to, it is evident that it does not mean that solid particles of a VCI, insoluble in the biopolymer, are readily uniformly distributed within it.

The '929 patent further states: “To offset the greater permeability and accessibility of the enclosure to corrosive atmospheres rich in water vapor, salt air, carbon dioxide, sulfur dioxide, hydrogen sulfide, or other gases which pose a threat to the surfaces of metallic objects, a vapor phase corrosion inhibitor in films of the type selected for this invention will provide significant protection for metallic articles, as well as other advantages.” (see col 2, lines 9-15). The data presented below provide evidence that the stated offset of WVTR, presumably due to the presence of the particles of VCI, does not occur with the addition of particles of inert filler in a much higher concentration than the VCI particles, and in a range of sizes from about 1-45 μm, the presence of the range of sizes being deliberately chosen to improve packing of the particles in the polymer. The expected offset of WVTR does not occur. Instead of the WVTR of neat polymer being decreased by addition of a large amount of filler powder packed and distributed uniformly throughout the biopolymer, the WVTR is increased.

The aforementioned '912 patent to Boerwinkle et al disclosed that any thermally processable organic polymers may be used in the preparation of a VCI-containing article and specifically disclosed polyolefins, polyolefin/polyester and polyester/-polyvinylchloride plastisols. The polyolefins included PE and polypropylene (“PP”); the polyolefin/polyester was commercially available Microthene FE-532 having randomly distributed chains of PE and polyvinylacetate, the chains being of arbitrary length.

The particular combination of VCI ingredients used in the '912 patent is an inorganic nitrite, a hindered phenol, and fumed silica; in particular, an alkali metal nitrite, e.g. potassium nitrite or sodium nitrite, in combination with a 2,4,6-tri-substituted phenol and fumed silica. A specific '912 combination in PE film comprised about equal parts (1.485 phr each) by weight of sodium nitrite and 2,6-di-tert-butyl-4-methyl phenol, along with 0.03 phr fumed silica, the film being extruded at 149° C. (300° F.). In view of the low concentration of VCI ingredients and inert filler in the '912 film, there was no concern with either the transparency of the film they prepared, or the primary particle size of the sodium nitrite; moreover, in view of the low concentrations of solid particles used, the '912 patent did not address the problems (i) of uniformity of distribution, (ii) of particle size, or (iii) of maintaining transparency of extruded film or molded articles having smooth surfaces.

From the foregoing '912 disclosure it is self-evident that a biodegradable film can be substituted for the films disclosed therein. It is also evident that neither the '912 nor the '929 patentees suggest using a relatively large amount of inert filler particles in the finished article. The disclosure in the '929 patent, suggesting that from 0-5% silica in the masterbatch of Formulation 4 should be diluted with any polyester to be used at a ratio of about 15 parts masterbatch to 85 parts polyester, indicates that, even if 5% silica was used in that masterbatch, the amount of silica in the finished article would be less than 1 wt %.

### SUMMARY OF THE INVENTION

A biodegradable polymer which has a WVTR in the range from at least twice to about 50 times greater than that of low density PE having a melt flow index of 1 g/10 min, each of the same thickness, may be filled with more than 5 wt %, and up to about 35 wt % of an inert particulate filler, and is not only substantially transparent if the neat biopolymer is transparent, as evidenced by a 0.025 mm thick cross-section, but also provides better corrosion protection than the PE film without decreasing the tensile strength of the film below a critical tensile strength of 2000 psi in either the machine or transverse direction, preferably in both directions. To obtain uniform dispersion of the particles in a biopolymer it is critical that the particles be dried at a temperature higher than a projected molding or extrusion temperature of the film, so that the particles are essentially anhydrous, preferably with less than 100 ppm moisture. Uniformity of distribution of the solid particles in the biopolymer is essential to avoid unduly decreasing the tensile strength of the filled biopolymer.

Despite containing from more than 5 wt % to 35 wt % of filler particles specified below, a “filled” biopolymer provides a higher WVTR than the “neat” biopolymer. The result of the higher WVTR of the filled biopolymer, which WVTR is from about 1% to 20% higher than that of the neat biopolymer, is that the polymer filled with both VCI ingredients and filler particles, provides at least as good protection as the unfilled biopolymer, and typically, better protection of metals against corrosion as measured below. Preferred biopolymers include aromatic-aliphatic copolyesters, aliphatic polyesters having repeating units having from 2 to 5 carbons atoms, and, polyesteramides formed by reaction with at least one diacid, at least one diol, and at least one amino acid.

The biofilm is uniquely adapted to be “filled” with a relatively high concentration, preferably from about 10-30 wt %, of micronized inert filler particles in the primary particle size range from about 1 μm - 45 μm, wherein at least 75% of the particles are smaller than about 20 μm, more preferably from about 1 μm-25 μm, wherein at least 75% of the particles are smaller than about 15 μm, in combination with at least one VCI which is in particulate form in the size range from about 1 μm-45 μm, and the particles are substantially uniformly dispersed in the polymer provided all ingredients added to the polymer before it is thermoformed are essentially anhydrous, that is, the moisture (water) content whether absorbed or not, is less than 0.05%, preferably less than 200 ppm, and most preferably less than 100 ppm. To obtain a substantially transparent cross-section of filed thermoformed biopolymer, the inert particles are required to be substantially light permeable, preferably having a refractive index ±20% of the refractive index of the neat polymer; the smaller the particles, the greater the tolerance in refractive index. The higher the light-permeability of the inert particles, the more transparent the filled polymer.

Most preferably the inert particles have an aspect ratio <10 so they are clearly not fiber fragments. By “aspect ratio” of an irregular particle is meant the ratio of its longest dimension in the longitudinal direction, divided by its longest dimension in a direction normal to the longitudinal direction. Moreover, though it would appear to be best to maximize the quantity of inert filler while minimizing the decrease in the strength and flexibility of the polymer, by using particles with a very low specific surface area (ideally 6/diameter, or “6/d”, for spherical particles), particles with irregular surfaces and a specific surface ratio greater than 12/d, more preferably from 12/d to 60/d are preferred. The specific surface ratio is the ratio of surface area to volume of a particle.

As one might theorize, particles with a refractive index relatively closely matched to that of the biopolymer are likely to be invisible when dispersed in the polymer; however, the high aspect ratio of the small particles causes such a high degree of scattering of light that the film would be expected to appear opaque, this being the same reason why a mass of finely divided talc (refractive index 1.573) and calcium carbonate (ref. ind. 1.63) particles appears opaque. Though one might expect a substantially transparent polymer film filled with less than 5 wt % of filler particles to be substantially transparent, it is unexpected that the polymer with more than 5 wt % and up to about 35 wt % of filler particles dispersed therein, would be thermoformed to provide a substantially transparent cross-section in the range from 0.025 mm to 0.125 mm thick.

A shaped article of an aromatic-aliphatic copolyester includes one or more VCI ingredients -in an amount less than 3 wt %, and from more than 5 wt % to about 35 wt % of an essentially anhydrous inert filler substantially uniformly distributed in the polymer so as to have a tensile strength of 2000 psi in at least one direction; further a cross-section of the article 0.025 mm thick, is substantially transparent and essentially free of agglomerates greater than 50 μm, that is, there are less than 5 such agglomerates/cm² of film which is 0.05 mm thick.

By “uniformly distributed” is meant that the uniformity of dispersed particles in the film may be quantified by known microscopic techniques, or by a blown film test. In the blown film test, the polymer containing solid powder particles is extruded through a blown film apparatus which produces a film about 0.025 mm (1 mil) thick, and this film is placed over a light source of appropriate wavelength and intensity to enable one to quantify the number of particles which show up as “imperfections”; and the size of each is also visible under appropriate magnification. No unit area of the film appears to have a substantially higher concentration of particles than another, that is, the variation in population density of the particles is less than ±20%, preferably less than about ±10%.

Though a two-stage process for blending ingredients into a polymer is conventional, it is generally not practiced to produce a finished film in which more than 5 wt %, preferably more than 10 wt % and most preferably more than 20 wt % of inert particles, are mixed with VCI particles, all particles to be uniformly distributed in the thermo-formed polymer which not only maintains high tensile strength, at least 2000 psi, but is susbtantially transparent. To produce such a finished film a modified two-stage process comprises, in a first stage, (i) adding from 0 wt %, preferably from 20 wt % to 100% of all the essentially anhydrous inert filler particles, and all the VCI ingredients to be present in the finished film, to essentially anhydrous biopolymer and blending at a temperature below the melting point of the biopolymer, to make a biopolymer concentrate in which the concentration of dispersed particles is in the range from about 25-60 phr, preferably about 50 phr (parts per hundred of blended concentrate) for 50 phr of biopolymer, (ii) further dispersing the inert particles and VCI ingredients in the biopolymer while melting the polymer to form a molten concentrate, preferably in the barrel of an extruder, (iii) cooling the molten concentrate into a solidified mass of arbitrary shape, and (iv) comminuting-the-solidified mass to form granules smaller than about 12.5 mm, preferably in a size range from about 2.80 mm (No. 7 Standard Test Sieve) to 9.5 mm (0.325″ sieve); and, in a second stage, (v) drying the granules to an essentially anhydrous condition, (vi) blending dried granules with at least twice as much fresh essentially anhydrous biopolymer so as to provide the desired amount of more than 5 wt % filler and less than 3 wt % of VCI ingredients in a finished blend, and (vii) thermoforming the finished blend into a desired substantially transparent shape having a tensile strength no lower than 2000 psi in at least one direction.

Though substantial transparency of a relatively thick cross-section >0.125 mm (5 mil) thick of an injection-molded article of the novel biopolymer may not be critical, as it is in a “see-through” biofilm, the same two stage process may be used to prepare an injection-moldable or cast “filled” biopolymer.

The aforementioned second stage process may be repeated on biopolymer (which has been formulated with filler and VCI ingredients, as previously described), in which the VCI ingredients have been depleted by long use. The biopolymer is recycled by simply adding the desired level of essentially anhydrous VCI ingredients to thoroughly dried VCI-depleted polymer.

### DETAILED DESCRIPTION OF THE INVENTION

In a most preferred embodiment, a shaped article comprises an essentially anhydrous aromatic-aliphatic copolyester having a tensile strength of at least 2000 psi at 23° C. in one direction, and a WVTR at atmospheric pressure (1 atm) at least about 5, preferably about 10 times higher than that of PE film, that is, greater than 10×0.5 g/m^{2/}24 hr/mm (g water per sq. meter per day per mm thickness); from about 5 to 30 wt % of an essentially anhydrous inert particulate filler in the size range from about 1 μm-45 μm, wherein at least 75% of the particles are smaller than about 20 μm, more preferably from about 1 μm-25 μm, wherein at least 75% of the particles are smaller than about 15 μm, and at least 1 percent by weight of a particulate, essentially anhydrous VCI ingredient having a primary particle size in the same aforestated size range as the filler, the filler and VCI both substantially uniformly dispersed in the polyester, the copolyester including the filler and VCI ingredient being essentially free of agglomerates greater than 50 μm and substantially transparent in a thickness of 0.05 mm.

A finished filled thermoplastic biopolymer in which the inert filler is uniformly distributed, is preferably made in a two-stage process, the first stage, comprising, (i) adding from 20 wt % to 100 wt % of essentially anhydrous inert filler particles, and all the VCI ingredients to be present in the finished film, to essentially anhydrous biopolymer. If the finished biopolymer is to have only 10 wt % of filler particles, then all or nearly all the particles may be added to the VCI ingredients and biopolymer to form a mixture. Then (ii) blending the mixture at a temperature below the melting point of the biopolymer, to make a biopolymer concentrate in which the concentration of dispersed particles is in the range from about 25-60 phr for 50 phr of biopolymer; (iii) further dispersing the inert particles and VCI ingredients while melting the polymer to form a molten concentrate, preferably in the barrel of an extruder; (iv) cooling the molten concentrate into a solidified mass of arbitrary shape; and, (v) comminuting the solidified mass to form granules smaller than about 12.5 mm.

The second stage comprises,

(vi) drying the granules to an essentially anhydrous condition;(vii) blending dried granules with at least twice as much fresh essentially anhydrous biopolymer so as to provide the desired amount of more than 5 wt %, but less than 35 wt % filler and less than 3 wt % of VCI ingredients in a finished blend; and, (viii) thermoforming the finished blend into a desired shape having a tensile strength no lower than 2000 psi in at least one direction.

The last step may be carried out in an injection molding machine, a blow molding machine, a slit extruder or, if film having a thickness in the range from about 0.025 mm to about 0.25 mm is desired, the film may be blown. Thicker films are typically cast.

The Fully Biodegradable Polymer:

Since the biopolymer chosen is required to maintain a minimum tensile strength when filled with micronized particles of inert filler and VCI ingredients, the neat biopolymer is limited to those having a tensile strength high enough so that when the polymer is infused with at least a total of 6 wt % of micronized particles, the tensile strength at ambient temperature is at least 2000 psi.

Though both rigid or “hard” typically injection-molded biopolymers may be used, preferred are those which are flexible and “soft”, such as those typically used for extruding film. “Hard” biopolymers, as defined herein, have a glass transition temperature “Tg” higher than about 0° C., while “soft” biopolymers have a Tg lower than 0° C. Typically, hard polymers have a Tg higher than about 25° C., harder biopolymers having a Tg greater than about 35° C. Soft polymers preferably have a Tg lower than about −15° C., most preferably lower than about −30° C. It is to be borne in mind that, once molten, there is no threat of rupture of the “filled” polymer being formed; however, upon cooling all the particles, both inert inorganic particles and VCI particles, whether they retained their particulate shape or are recrystallized upon cooling, represent discontinuities in the film and the significance of the Tg, though correlatable only in general terms to the melting point of the film, is confirmed when a thin cross-section of the biopolymer is to be thermoformed.

Preferred “hard” biopolymers, such as are typically used for injection molding applications, include terpolymers based on polylactic acid, and other polylactic acid-based polymers, polyesteramides, polyglycolic acid, poly(lower C₂-C₅ alkylene carbonates, and modified polyethylene terephthalates, all commercially available from Bayer, Cargill-Dow Polymers, Dianippon Ink, Du Pont, Mitsui Chemicals, PAC Polymers, inter alia.

Preferred hard injection-molding biopolymers include modified polyethylene terephthalate (PET) Biomax® biopolymers (DuPont) described in greater detail in U.S. Pat. Nos. 5,053,482 and 5,097,005 to Tietz, U.S. Pat. Nos. 5,097,004 5,171,308 and 5,219,646 to Gallagher et al., U.S. Pat. No.5,295,985 to Romesser et al. Such biopolymers typically consist essentially of alternating terephthalate and an aliphatic units derived from at least two diols. Biomax polymers have a m pt in the range from about 200-208° C. and a Tg in the range from about 40-60° C.

Also injection moldable or extrudable is filled polylactic acid (PLA) in the molecular weight range of Mn from about 50,000 to 110,000. Commercially available PLA has a m pt of about 180° C. and a Tg of about 60° C.

Still other moldable or extrudable biopolymers are polyesteramides, e.g. BAK 1095(BASF)-made-by reacting-adipic acid, 1,4-butaneldiol and 6-aminocaproic acid and having a Mn of about 22,700 and a Mw of about 69,700, a m. pt. of 125° C.; and BAK 2195 which has a m pt of 175° C.; and a terpolymer of polylactide, polyglycolide and polycaprolactone produced by Mitsui Chemicals, Inc. using a condensation reaction, three of which are sold under the designations H100J, S100 and T100. The H100J has a Tg of about 74° C. and a m.pt of 173° C.

Preferred “soft” biopolymers are aliphatic-aromatic copolyesters; aliphatic polyesters such as polyhydroxyvalerate, polyhydroxybutyrate-hydroxyvalerate copolymer and polycaprolactone; and succinate-based aliphatic polymers, e.g., polybutylene succinate. polybutylene succinate adipate, and polyethylene succinate, all of which are commercially available from manufacturers such as BASF, Daicel Chemical, Eastman Chemical, Monsanto, Showa High Polymer, Solvay, and Union Carbide.

Most preferred aliphatic-aromatic copolyesters are disclosed in U.S. Pat. No. 5,817,721 to Warzelhan et al (BASF), and U.S. Pat. Nos. 5,292,783, 5,446,079, 5,559,171, 5,580,911, 5,599,858 and 5,900,322, to Buchanan et al (Eastman Chemical), the relevant disclosures of each of which is incorporated by reference thereto as if fully set forth herein.

In the examples presented below, the biopolymer used for extruding or blowing film is Ecoflex® (BASF), believed to be formed by reaction of adipic acid, 1,4-butanediol and dimethyl-terephthalate (DMT), which biopolymer has a Tg of −33° C. and a m pt in the range from about 105° C. −115° C. The thickness made and used is in the range from about 0.025 mm (1 mil) to 0.125 mm (5 mil), the thinner film being used to carry lighter loads than the thicker film, and also for faster decomposition, if the biopolymer is not to be recycled after the VCI is depleted.

Equally useful for film, whether blown or extruded, is another biopolymer, Eastar Bio® (Eastman) believed to be a random copolymer formed by reaction of the same ingredients as the Ecoflex and having essentially the same physical properties. Eastar Bio has a tensile strength at break in the machine direction of 19 MPa, an elongation at break of 600%, a tensile modulus of elasticity of 97 MPa (tangent), and an Elmendorf tear strength of 282 g.

Also useful for film is polycaprolactone (PCL), formed by polymerizing ε-caprolactone, the polymer having a relatively low melting point and a low glass transition temperature. The Tg of PCL is −60° C. and the m pt is only 60° C. Because of this, PCL and other similar aliphatic polyesters with low melting points are difficult to process by conventional techniques such as film blowing and blow molding. Film made from PCL is tacky as extruded and has low melt strength near its m pt. Also, the slow crystallization of this polymer causes the properties to change over time. Blending PCL with the inert filler improves the processability of PCL and reduces tackiness. Commercially available PCLs are manufactured by Union Carbide (Tone®), Daicel Chemical, Ltd. and Solvay.

Another “soft” aliphatic polyester that may be used are (i) polyhydroxybutyrate-hydroxyvalerate copolymer, made using a microbial-induced fermentation, e.g. Biopol® (Monsanto) which has a Tg of about 0° C. and a m. pt of about 170° C.; and (ii) a polyhydroxy-alkanoate Metabolix®

Still other “soft” aliphatic polyesters are based on repeating succinate units such as polybutylene succinate, polybutylene succinate adipate, and polyethylene succinate e.g. Bionolle® from Showa High Polymer, Ltd., which has a Tg of −30° C. and a m pt of 114° C.

The choice of the biopolymer depends upon the amount of filler particles to be added—the higher the wt % of filler particles, the higher the tensile strength required of the biopolymer chosen; typically, loadings of filler higher than 20 wt % yet meeting the requirement of a 200 psi tensile strength for filled biopolymer, requires choosing a biopolymer having a tensile strength greater than at least about 3000 psi in at least one direction.

The Particulate Filler:

Though the specific reason for adding more than 5 wt % of inert filler particles is to increase the WVTR, such addition has additional effects on other physical properties of the polymer, such as the tendency to self-adhere during processing, to increase stiffness (undesirable except in injection molded, or compression molded rigid articles) and compressive strength; and also to reduce the cost of filled VCI biopolymer. Since the packed inert filler particles function to increase the mean free path of water vapor through the filled polymer the particles may be either inorganic or organic particulate fillers, so long as they are environmentally friendly. However, inorganic fillers are preferred among which are silica, talc, calcium carbonate, titanium dioxide, pumice, and the like which are readily dried to essentially anhydrous conditions. Because of the high scattering of light at the aspect ratios of filler particles used herein, the refractive indices of the filler particles is not narrowly critical. The optimum amount to be used for a finished article having desired strength properties may be determined by a microstructural engineering approach, choosing an appropriate aspect ratio and specific surface area, and such amount will provide the desired higher WVTR relative to less filled polymer.

Preferred particles have a surface area in a range from about 100 m²/g to 1000 m²/g, more preferably in range from about 300 m²/g to 800 m²/g, and most preferably in a range from about 500 m²/g to 600 m²/g. Most preferred are talc particles in the size range from about 0.5-25 μm, more than 50% of which are in the range from 4-9 μm; and calcium carbonate particles in the size range from about 0.4-70 μm, more than 50% of which are in the range from 5-20 μm, both ranges measured by Microtrac-X100.

Though it may be best to grind inert particles to calculated size ranges which will afford highest packing, it is found that a random distribution of sizes in the aforestated range, or a distribution in a typical bell-shaped curve, provides excellent packing and a high reduction in interstitial space (between particles) as the smaller particles occupy space between larger particles.

The VCI ingredient:

Preferred inorganic VCIs include alkali metal molybdates and alkali metal nitrites, most preferably sodium molybdate and sodium nitrite. Preferred organic VCIs include amine salts, ammonium benzoate, alkali dibasic acid salts, tall oil imidazolines, and triazole compounds, most preferably benzotriazole, sodium sebacate and dicyclohexylammonium nitrite. It will be appreciated that the size of particles of an organic VCI which melts under thermoforming conditions is immaterial, and that the VCI crystallizes in the biopolymer when cooled, and adds to the particle density in the biopolymer.

The amount of the VCI ingredients used is chosen to be effective for a predetermined period, from 1 to 10 years for metal objects which might be stored a long time, but typically from 1 to 5 years. Even for the longer period, the amount of VCI dispersed in the biopolymer is less than 3 wt %, and for shorter periods, less than 1 wt %.

The following illustrative examples, in which “parts” refers to parts by weight, describes the production of Ecoflex® biofilm packed with both VCI and inert filler particles.

### EXAMPLE 1

Sodium silicate (7 parts), sodium nitrite (90 parts) and Cabosil® fumed silica (3 parts) are ground to a size range from about 1-45 μm (bell curve, Microtrac-X100), and thoroughly mixed into a powder blend. The powder blend is then dried at 250° C. for 3 hr.

Particulate Ecoflex® FBX 7011 (50 parts) as received is dried at 95° C. for 3 hr and mixed with the dried powder blend (50 parts) in a kitchen blender for 15 minutes. The mixture is then fed to the feed port of a twin-screw rotating Century® extruder having L/D=40 and screw diameter =30 mm, in which extruder most of the zones are controlled at temperatures in the range from about 63.3° C. (146° F.) to 79.9° C. (176° F.). The die temperature is maintained at 64.9° C. (149° F.). The motor speed is about 150 rpm at 47% torque exerting about 620 kPa (90 psia) generates a “noodle” which is cooled in a water bath, pelletized into pellets about 3.18 mm (0.125 in) and dried.

Talc powder, mean diameter 2.2 μm, sp gr 2.8, in the aforestated size range, from Luzenac® is dried at 250° C. for 3 hr and 20 parts by wt are thoroughly blended with dried Ecoflex® FBX 7011 (78 parts) and the pellets of masterbatch (2 parts) in a high-speed blender for 15 minutes. The blended mixture is then fed to the feed port of the Century extruder with the same screw configuration as before. Most of the zones are controlled at temperatures in the range from about 62.7° C. (145° F.) to 78.3° C. (174° F.) The die temperature is maintained at 63.8° C. (147° F.). The motor speed is about 177 rpm at 50-55% torque exerting about 627 kPa (91 psia) generates a noodle which is cooled in a water bath, and pelletized as before.

Production of Blown Biofilm:

The pellets of the blended mixture are dried to essentially anhydrous conditions then immediately fed to a Killion single screw blown film unit which has-been thoroughly purged by flushing with low density PE (melt flow index 4-5 g/10 min) at about 187.6° C. (370° F.).

Details of the Killion unit are as follows:

L/D=25/1; screw diameter 25.4 mm; die inner diameter 50.8 mm; die gap size 1.5 mm; blow up ratio=2 to 2.5.

The pellets melt in the range from 182° C. (360° F.)-195.9° C. (385° F.). Die temperatures are set in the range from about 182° C. (350° F.)-193.1° C.(380° F.); zone temperatures are set in the range from 201.4° C. (395° F.)-212.6° C. (415° F.); speed is about 12 rpm and pressure exerted is in the range from 8.27 Mpa (1200 psia)-11.02 Mpa (1600 psia); film is blown at about 5 ft/min. Production of the blown film commences at low rotation speed (screw speed) so that the raising of a flexible bubble is slow and uniform. If cooled internally, a minimum amount of air is used and tension at the film winder is set very low. Thickness of the blown film is in the range from 0.025 mm (1 mil) to 0.375 mm (1.5 mil).

The tensile strength of neat blown Ecoflex film using ASTM D-882 testing procedure, is in the range from about 32-36 N/mm² (4634-5213 psi).

The tensile strength of blown film filled with both VCI and filler particles using the same ASTM D-882 testing procedure is in the range from about 13.8-20.7 N/mm² (2000-3000 psi), the more the filler and VCI particles, the lower the tensile strength.

### EXAMPLE 2

In a manner analogous to that described in Example 1 above, 90 Zinc oxide (54 parts), sodium silicate (25 parts) are ground to a size range from about 1-45 μm (bell curve, Microtrac-X100), and mixed, then Cobratec® 99 benzotriazole (10.5 parts), Naugard® 2,6 di-t-butyl-4-methyl phenol (10.5 parts) thoroughly mixed into the mixture.

Though the zinc oxide particles function as filler particles they also have a beneficial effect on the corrosion-protection properties of the thermoformed biopolymer. The diluted biopolymer may be extruded through a slit die or blown into film using a procedure analogous to that described above in Example 1.

### EXAMPLE 3

Production of Crosslinked Eastar Bio GP® (Eastman Chemicals):

This biopolymer is crosslinked using a free radical initiator, specifically 0.1 part of 2,5-bis(t-butylperoxy)-2,5-dimethylhexane (Luperox® 101) in 100 parts of the biopolymer, in the Century extruder under conditions similar to those described in Example 1 above, and pelletized as described. The pellets are then mixed with the ingredients specified in Example 1 to make a powder blend which is then extruded and pelletized as a master batch which in turn is mixed with 78 parts of neat crosslinked polymer as before, and extruded and pelletized as before. The pellets are then dried to essentially anhydrous conditions and blown into film in a manner analogous to that described above.

Since the tensile strength of the crosslinked bioopolymer is higher than its uncrosslinked strength, this crosslinked biopolymer is preferred for higher strength requirements, and may be blown into film using a procedure analogous to that described above in Example 1.

### EXAMPLE 4

Production of Cast Film with a Slit Die:

An extruder thoroughly mixes and disperses the inert particles and VCI ingredients and feeds molten polymer through a slot or flat die to form a thin molten sheet of film. This film is “pinned” to the surface of a chill roll which is typically chrome-plated and water-cooled, by a blast of air from an air knife or vacuum box. The film quenches immediately and then has its edges slit prior to winding.

### EXAMPLE 5

Testing of film for Uniformity of Dispersion of the particles:

A film of Eastar Bio GP biopolymer prepared with about 1 wt % of the VCI formulation set forth in Example 1 and filled with 20 wt % talc particles, about 90% of which are in the size range from 1-15 μm was-blown to a thickness of 0.025 mm and placed viewed against a ?? light. The distribution of particles over each unit area appears to be substantially the same to the naked eye.

### EXAMPLE 6

Testing of “filled” film for Tansparency (20 wt % filler particles):

A film of Ecoflex biopolymer prepared with about 1 wt % of the VCI formulation set forth in Example 1 and filled with 20 wt % talc particles in the size range from ??-?? μm was blown to a thickness of 0.025 mm and placed over text in 12-point size. The text is readily read by the human eye.

### EXAMPLE 7

Comparison of WVTR of low density PE and biopolymers:

Films are prepared from “neat” low density Petrothene® NA 960 PE from Equistar having a melt index of about 1 g/10 min, and “neat” biofilms each film at least 0.025 mm (1 mil) thick; and filled films are made with the stated amount of filler. The amounts of particles in each film is given, the remaining being polymer; the designation “VCI” indicates that the film contained the stated about 1 wt % of the combination of VCI ingredients used in Example 1. Various samples tested below were locked over a test dish and measurements made according to ASTM E96-00 “Standard Test Methods for Water Vapor Transmission of Materials”. Whatever the thickness of the film, whether greater or less than 0.025 mm, the WVTR which is measured as (g of water/100 in²/mil/day) is normalized to (g of water/metei2 /mm/day). The experimental error for the method is estimated to be about 10%. A statistically significant number of measurements are made (five) and the average read.

The results, normalized to (gm of water/m²/day/mm) are set forth below:

| Polymer film | wt % VCI | wt % talc | WVTR |
|---|---|---|---|
| Petrothene NA 960 | 0 | 0 | 0.5 |
| Pewtrothene NA 960 | 1 | 0 | 0.6 |
| Petrothene NA 960 | 1 | 29 | 1.5 |
| Ecoflex FBX 7011 | 0 | 0 | 7.0 |
| Ecoflex FBX 7011 | 1 | 5 | 7.1 |
| Ecoflex FBX 7011 | 1 | 29 | 8.0 |

It is noted that though the experimental error precludes making a “hard” distinction between 0.5 g/m²/day/mm for neat PE and 0.6 g/m²/day/mm for PE containing 1 wt % VCI ingredients, the value measured is always higher, not lower. Note that even if a far more accurate measurement could be made, the contribution of 1 wt % solid particles in either direction, if linear, would only make a 1% difference in WVTR.

The WVTR of the PE with 29 wt % filler is more than double that of the PE without filler.

The WVTR of Ecoflex with 1 wt % VCI ingredients is only slightly higher than that for neat Ecoflex, but the WVTR of the Ecoflex filled with 29 wt % talc particles is about 14% higher.

It is evident from the higher WVTRs of the filled polymer that the increased amount of filler particles, over the 1 wt % of VCI ingredients, serves to increase the WVTR, not decrease it.

### EXAMPLE 8

Comparison of Corrosion Protection

Corrosion is measured according to IEC 68-2-30 the requirements of which are incorporated by reference thereto as if fully set forth herein, using aggressive conditions for relative humidity in a Thermatronp® as follows:

Test specimens of 1010 carbon steel 25.4 mm ×44.4 mm (1″×1.75″) are subjected to repetitive 24 hour cycles over 10 days, cycling the conditions of exposure. Each cycle commenced at 25° C. and 98% relative humidity with an initial period of 6 hours, after which the temperature setting was raised to 55° C. and the relative humidity lowered to 93%. After 3 hr the relative humidity and temperature are set as follows: (i) the relative humidity is lowered to 93% and is maintained at this humidity for 6 hr; and (ii) the temperature is lowered to 25° C. and remains at this temperature for the remaining 15 hr of the 24 hr cycle. After 6 hr, and 15 hr after the cycle commenced, the relative humidity is raised to its starting 98% level and maintained for the remaining 9 hr of the cycle.

The samples are subjected to 10 cycles consecutively. In each case, the specimens are protected by film-having a thickness of 0.05 mm (2 mil); six (6) carbon steel specimens are used, and the average number of corrosion spots read.

| | WVTR | Corrosion spots |
|---|---|---|
| Neat Petrothene PE | 0.8 | >20 |
| Neat Ecoflex | 7.0 | 3 |
| Ecoflex with 29 wt % filler | 8.0 | 3 |
| Ecoflex with 29 wt % filler + VCI 1 wt % | 8.0 | 2 |

It is evident from the foregoing data that the neat Ecoflex which has a much higher WVTR is more effective than the neat PE; further that though the WVTR of the Ecoflex with 29 wt % filler and VCI 1 wt % is 14% higher than the filled Ecoflex without the VCI, the corrosion protection is 50% better.

We claim:

1. A shaped article of arbitrary shape and size comprising, an essentially anhydrous biodegradable polymer (“biopolymer”) having a WVTR in the range from at least twice to about 50 times greater than that of low density polyethylene having a melt flow index in the range from 4-5 g/10 min;
from more than 5 and up to 35 percent by weight of an essentially anhydrous inert particulate filler substantially uniformly dispersed in the biopolymer, the filler having a primary particle size in the range from about 1 μm-45 μm, wherein at least 75% of the particles are smaller than 25 μm;
from about 1% to 3% by weight of particulate, essentially anhydrous volatile corrosion inhibiting (VCI) ingredients substantially uniformly distributed within the polymer, the ingredient in the article having a primary particle size in the same size range as the filler;
the biopolymer including the filler and the VCI ingredient having a tensile strength of at least 2000 psi at 23° C. in at least one direction.

2. The shaped article of claim 1 wherein the biopolymer is selected from the group consisting of an aromatic-aliphatic copolyester, an aliphatic polyester having repeating units having from 2 to 5 carbons atoms, and, a polyesteramide formed by reaction with at least one diacid, at least one diol, and at least one amino acid.

3. The shaped article of claim 2 is film having a thickness in the range from about 0.025 mm (1 mil) to 0.125 mm (5 mils) which film is substantially transparent in a thickness of 0.025 mm and essentially free of agglomerates greater than 50 μm; and each unit area of biofilm 0.025 mm thick, containing solid powder particles dispersed therein, has a variation in population density of the particles which is less than ±20%.

4. The shaped article of claim 3 wherein the film has a thickness in the range from about 0.025 mm (1 mil) to 0.125 mm (5 mils), and a variation in population density of the particles which is less than ±10% from one unit area of the film to another.

5. The shaped article of claim 4 wherein the film is an aromatic-aliphatic copolyester.

6. A two-stage process for producing finished filled thermoplastic biopolymer in which the inert filler is uniformly distributed, in a first stage, comprising,
(i) adding from 20 wt % to 100 wt % of essentially anhydrous inert filler particles, and all the VCI ingredients to be present in the finished film, to essentially anhydrous biopolymer;
(ii) blending the mixture at a temperature below the melting point of the biopolymer, to make a biopolymer concentrate in which the concentration of dispersed particles is in the range from about 25-60 phr for 50 phr of biopolymer;
(iii) further dispersing the inert particles and VCI ingredients while melting the polymer to form a molten concentrate, preferably in the barrel of an extruder;
(iv) cooling the molten concentrate into a solidified mass of arbitrary shape; and,
(v) comminuting the solidified mass to form granules smaller than about 12.5 mm; and in a second stage comprising,
(vi) drying the granules to an essentially anhydrous condition;
(vii) blending dried granules with at least twice as much fresh essentially anhydrous biopolymer so as to provide the desired amount of more than 5 wt %, but less than 35 wt % filler and less than 3 wt % of VCI ingredients in a finished blend; and,
(viii) thermoforming the finished blend into a desired shape having a tensile strength no lower than 2000 psi in at least one direction.

7. The process of claim 6 wherein step (viii) comprises blowing film having a thickness in the range from about 0.025 mm to 0.25 mm, and the film is substantially transparent.

8. The process of claim 6 wherein step (viii) comprises injection molding a shaped article.

9. The process of claim 7 wherein in step (ii) blending the mixture to make a biopolymer concentrate in which the concentration of dispersed particles is 50 phr for 50 phr of biopolymer.
